(19) United States
(12) Patent Application Publication
(10) Pub. No.: US 2011/0028662 A1
(43) Pub. Date: Feb. 3, 2011

(54) PEG-COATED CORE-SHELL SILICA NANOPARTICLES AND METHODS OF MANUFACTURE AND USE

(75) Inventors: Ulrich Wiesner, Ithaca, NY (US); Hooisweng Ow, Ithaca, NY (US)

Correspondence Address: MORRISON & FOERSTER LLP, 425 MARKET STREET, SAN FRANCISCO, CA, 94105-2482, US

(73) Assignee: HYBRID SILICA TECHNOLOGIES, INC., Ithaca, NY (US)

(21) Appl. No.: 12/675,210

(22) PCT Filed: Aug. 29, 2008
(86) PCT No.: PCT/US08/74894

§ 371 Date: Sep. 1, 2010

Related U.S. Application Data
(60) Provisional application No. 60/969,561, filed on Aug. 31, 2007.

(51) Int. Cl. C08G 77/00

(52) U.S. Cl. 525/478

(57) ABSTRACT

Described herein are PEG-coated, core-shell nanoparticles, which display reduced aggregation and/or reduced non-specific or undesired attachment characteristics. These fluorescent nanoparticle include: a silica-based core having an organic functional group that includes a mercapto substituent, an organic fluorescent compound, a silica shell; and a silane-PEG compound. The silica shell of the nanoparticle encapsulates the silica-based core and the silane-PEG compound is conjugated to the silica shell.

### BACKGROUND

1. Field

The present application relates generally to nanoparticles, and more specifically to fluorescent nanoparticles coated with polyethylene glycol (“PEG”). Also described are methods of manufacture and use of the PEG-coated, fluorescent nanoparticles.

2. Related Art

U.S. Patent Publication Nos. 2004/0101822 A1 and 2006/0245971 A1, which are hereby incorporated by reference in their entireties, describe fluorescent core-shell silica nanoparticles (hereinafter “CS nanoparticles”) with various ligands attached to their surfaces and fluorescent dyes incorporated into their cores and/or shells. In one embodiment of the CS nanoparticles, the nanoparticles are capable of emitting in the near-infrared spectral range, after excitation. Accordingly, the CS nanoparticles may find use in various detection methods. In one instance, the CS nanoparticles may be used, in vivo, as part of a system to visualize the vascular system of a subject undergoing surgery, due to their small size and high signal-output.

In vivo use of nano-sized particles often presents the challenge of particle aggregation. Particle aggregation or agglomeration, a process in which the nano-sized particles associate via covalent and non-covalent interactions to form larger complexes, may create larger-sized complexes, thereby inhibiting the mobility and utility of the nano-sized particles. Nano-sized particles may also attach non-specifically to tissues, which also limit their usefulness.

There is a need for an improved CS nanoparticle that exhibits reduced aggregation and/or non-specific or undesired attachment characteristics.

### SUMMARY

Described herein are PEG-coated CS nanoparticles, which display reduced aggregation and/or reduced non-specific or undesired attachment characteristics.

To prevent agglomeration and sticking, CS nanoparticles were coated with compounds (ligands) associated with the silica particle surface that contain at least one hydrophilic part. Association could be achieved, e.g., via covalent silane-based coupling chemistry. Exemplary compounds containing a hydrophilic part are silane-PEG (silane-polyethylenglycol) compounds. In one exemplary embodiment, the silane-PEG is Methoxy(Polyethyleneoxy)Propyl]-Trimethoxysilane (CH₃(OC₂H₄)₆₋₉(CH₂)OSi(OCH₃)₃).

Coating the nanoparticles with hydrophilic compounds, like modified PEGs may have multiple benefits. First, it may reduce nanoparticle aggregation. Second, it may reduce unspecific binding of other compounds in blood, like proteins, to the particle surface preventing their retention in organs and other tissues, allowing them to circulate in the blood stream until they are cleared via renal excretion.

### DESCRIPTION OF THE DRAWING FIGURES

FIG. 1 illustrates the results of fluorescence scan comparing exemplary PEG-coated CS nanoparticles, non-PEG-coated CS nanoparticles, and free dye precursor. Fluorescence units, normalized to free dye precursor output, is provided in the Y-axis, with the wavelength of fluorescence provided in the X-axis;

FIG. 2 illustrates an exemplary method of PEG-coating CS nanoparticles and post-coating filtration and size selection;

FIG. 3 depicts size distribution of CS particles synthesized by a protocol where the cores are coated with a shell of PEG coating compound, such as [Methoxy(Polyethyleneoxy)Propyl]-Trimethoxysilane or hetero-bifunctional PEG compounds, such that the complete CS particles have diameter less than 7 nm.

FIG. 4 depicts size characterization by fluorescence correlation spectroscopy of 6 nm CS particles after 14 days in various buffered salt solutions.

FIG. 5 illustrates a potential, exemplary method of visualizing the renal vascular system, especially the urinary tract, using exemplary PEG-coated CS nanoparticles, described herein;

FIG. 6 illustrates a bio-distribution comparison of water (control), non-PEG-coated CS nanoparticles, and PEG-coated CS nanoparticles;

FIG. 7 illustrates a concentration/time comparison in blood and urine of non-PEG-coated CS nanoparticles and PEG-coated CS nanoparticles;

FIG. 8 illustrates an analysis of coated CS nanoparticle size to relative fluorescence, as a function of CS nanoparticle excretion.

### DETAILED DESCRIPTION

### 1. Coated CS Nanoparticles

Described herein are fluorescent, core-shell silica nanoparticles with one or more ligands associated to their surface. The underlying CS nanoparticle may be, without limitation, any CS nanoparticle described in U.S. Patent Publication Nos. 2004/0101822 A1 and/or 2006/0245971 A1. For example, the CS nanoparticle may be a silica nanoparticle having a core that includes a mercapto function group or a silica nanoparticle having a first reference dye incorporated into the core and a second sensor dye incorporated into the shell.

The CS nanoparticle may be associated with a ligand. Ligands which may be associated with the CS nanoparticles include the ligands described in U.S. Patent Publication No. 2004/0101822 A1 and the ligands described herein. For example, ligands which may be associated with a CS nanoparticle include, among others: a biopolymer, a synthetic polymer, an antigen, an antibody, a virus or viral component, a receptor, a hapten, an enzyme, a hormone, a chemical compound, a pathogen, a microorganism or a component thereof, a toxin, a surface modifier, such as a surfactant to alter the surface properties or histocompatability of the nanoparticle or of an analyte when a nanoparticle associates therewith, and combinations thereof. Preferred ligands are for example, antibodies, such as monoclonal or polyclonal. The ligand associated with a CS nanoparticle may also be a fluorescence quencher molecule like a Black Hole Quencher (BHQ) molecule specific for quenching of the fluorescence light emitted by the CS nanoparticles. This quencher molecule is linked to the CS nanoparticle directly to the silica surface or alternatively on a PEG molecule through a cleavable linker (for example a peptide or a nucleotide). The linker is cleavable for example by proteases which are specific for certain amino acid sequence or by nucleases specific for a certain nucleotide sequence. In this way the presence of linker cleaving agents (e.g. proteases or nucleases) could be detected since the quencher molecule is removed from the CS nanoparticle surface and fluorescence can be detected. Uses of fluorescence quencher molecules were described by Zheng, G., J. Chen, et al., which is hereby incorporated by reference. Zheng, G., J. Chen, et al., (2007). Photodynamic molecular beacon as an activatable photosensitizes based on protease-controlled singlet oxygen quenching and activation. Proc Natl Acad Sci USA 104(21): 8989-94.

In one embodiment, the ligand associated with the CS nanoparticle is a ligand containing at least one hydrophilic moiety, for example, Pluronic® type polymers (a nonionic polyoxyethylene-polyoxypropylene block co-polymer with the general formula HO(C₂H₄O)a(-C₃H₆O)b(C₂H₄O)aH), a triblock copolymer poly(ethylene glycol-b-(DL-lactic acid-co-glycolic acid)-b-ethylene glycol) (PEG-PLGA-PEG), a diblock copolymer polycaprolactone-PEG (PCL-PEG), poly(vinylidene fluoride)-PEG (PVDF-PEG), poly(lactic acid-co-PEG) (PLA-PEG), poly(methyl methacrylate)-PEG (PMMA-PEG) and so forth. In an embodiment with such a moiety, the hydrophilic moiety is a PEG moiety such as: a [Methoxy(Polyethyleneoxy)Propyl]-Trimethoxysilane (e.g., CH₃(OC₂H₄)₆₋₉(CH₂)OSi(OCH₃)₃), a [Methoxy(Polyethyleneoxy)Propyl]-Dimethoxysilane (e.g., CH₃(OC₂H₄)₆₋₉(CH₂)OSi(OCH₃)₂) or a [Methoxy(Polyethyleneoxy)Propyl]-Monomethoxysilane (e.g., CH₃(OC₂H₄)₆₋₉(CH₂)OSi(OCH₃)). In another embodiment, sufficient quantities of the ligand are attached to coat the CS nanoparticle. In principle, the chain of the coating compounds can have a length between 1 and 100 monomer units, preferably between 4 and 25 units. In embodiments employing PEG chains, instead of a methoxy-group a hydroxyl group (—OH) can be at the polymer end.

In embodiments employing shorter PEG chains, the resulting CS nanoparticle has a smaller diameter. In one embodiment of a method of use for the PEG-coated CS nanoparticles described herein, a relatively small diameter is allows for renal excretion or improved renal excretion, relative to larger diameter CS nanoparticles. By way of example, after an additional separation step shorter PEG-coated CS nanoparticles were obtained with a hydrodynamic radius of 4 nm and a narrow particle size distribution as measured by fluorescence correlation spectroscopy.

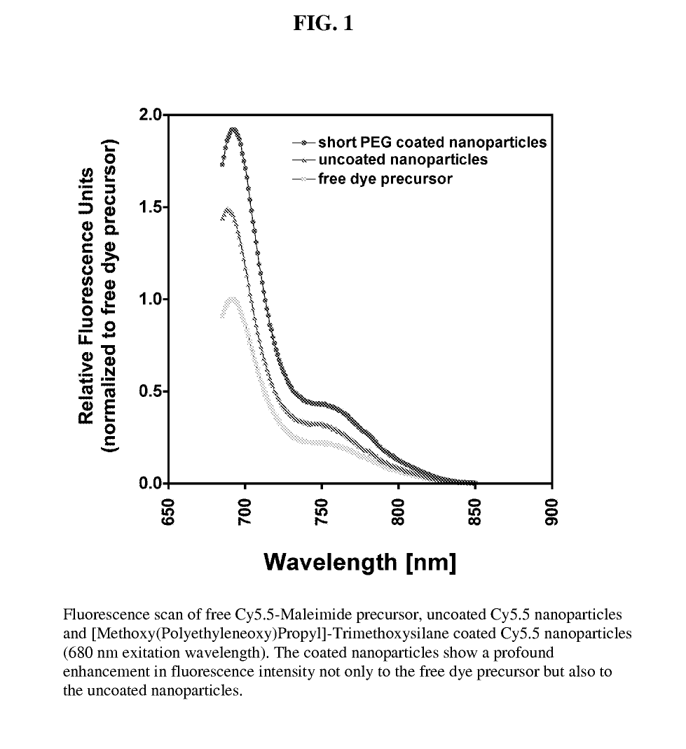

With reference to FIG. 1 and as noted in U.S. Patent Publication No. 2004/0101822 A1, a non-PEG-coated CS nanoparticle that comprises a fluorescent dye has a per dye brightness that is enhanced over that of the free dye in aqueous solution. Another advantage of the PEG nanoparticle coatings described here is an observed further fluorescence brightness enhancement per dye over the uncoated, CS nanoparticle. The improvement of the signal-to-noise ratio, even over that of uncoated CS nanoparticles, is advantageous in many in-vitro as well as in-vivo methods of employing nanoparticles.

In addition to improved signal, PEG-coated CS nanoparticles markedly reduce mortality rates in experimental test subjects. For instance, the intravenous injection of uncoated sub 10 nm silica nanoparticles can lead to the death of the experimental animal. For example, in one experiment a group of 5 mice died when they where injected with a dose of 200 μl of a 2.7 mg/ml uncoated dot solution. In contrast, 5 mice injected with a similar dosage of [Methoxy(Polyethyleneoxy)Propyl]-Trimethoxysilane coated CS nanoparticles experienced a zero rate of mortality.

### 2. Methods of Preparing Coated CS Nanoparticles

Methods for preparing the coated CS nanoparticles described herein may be understood through the following exemplary method of preparing a [Methoxy(Polyethyleneoxy)Propyl]-Trimethoxysilane coated CS nanoparticle.

CS nanoparticles used for the described application are synthesized through the process described by Wiesner and Ow in US Patent Publication No. 2004/0101822A1, so that they have a diameter of below 10 nm, according to measurements with dynamic light scattering. In one embodiment, the complete, coated CS nanoparticles maintain a total diameter below 10 nm. The resulting CS nanoparticles are dialyzed against methanol. After those steps they have a concentration of approximately 10 mg/ml.

The CS nanoparticles are subsequently coated with [Methoxy(Polyethyleneoxy)Propyl]-Trimethoxysilane. The necessary amount is calculated by first estimating the total amount of surface silanols in a given volume of nanoparticle solution as described by Tripp and Hair, which is hereby incorporated by reference. Tripp, C. P. and M. L. Hair (1995). Reaction of Methylsilanols with Hydrated Silica Surfaces: The Hydrolysis of Trichloro-, Dichloro-, and Monochloromethylsilanes and the Effects of Curing. LANGMUIR 11(1): 149-155. Knowing the amount of surface silanols and thus the amount of silane compound (coating materials) required for a monolayer coverage of the surface, ten-fold excess of the coating compound [Methoxy(Polyethyleneoxy)Propyl]-Trimethoxysilane is then diluted in a volume of methanol which is double the volume of the nanoparticle solution to be coated Ammonia is added to this solution in order to attain an end concentration of 0.2 molar. The nanoparticles are pipetted under constant stirring into the methanol/ammonia/[Methoxy(Polyethyleneoxy)Propyl]-Trimethoxysilane mixture and stirring is continued at room temperature for 12 h. Finally the nanoparticles are dialyzed in ultra pure water.

In one embodiment, the PEG coating compound is provided as a hetero-bifunctional PEG compound. The functional groups may be, but are not limited to a maleimide functional group, an ester functional group, and a hydroxyl functional group. One functional group of the hetero-bifunctional PEG compound may be reacted to form a silane for conjugation to the silica shell of the CS nanoparticles. The second functional group may be reacted to link a ligand. The ligand may be any ligand described in U.S. Patent Publication No. 2004/0101822 A1. In one embodiment the ligand includes a targeting moiety capable of recognizing a target molecule or substrate.

In embodiments wherein the coating process is performed with very short hydrophilic compounds like silane-PEGs, e.g., with up to 10 monomer units, and with sodium acetate buffer as catalyst and only water as solvent, this results in immediate flocculation of the short PEG-silane even before the nanoparticles are added. This makes the coating process ineffective. The use of the smaller catalyst Ammonia and nearly water free, or in water and alcohol mixtures, reaction conditions resolved this problem.

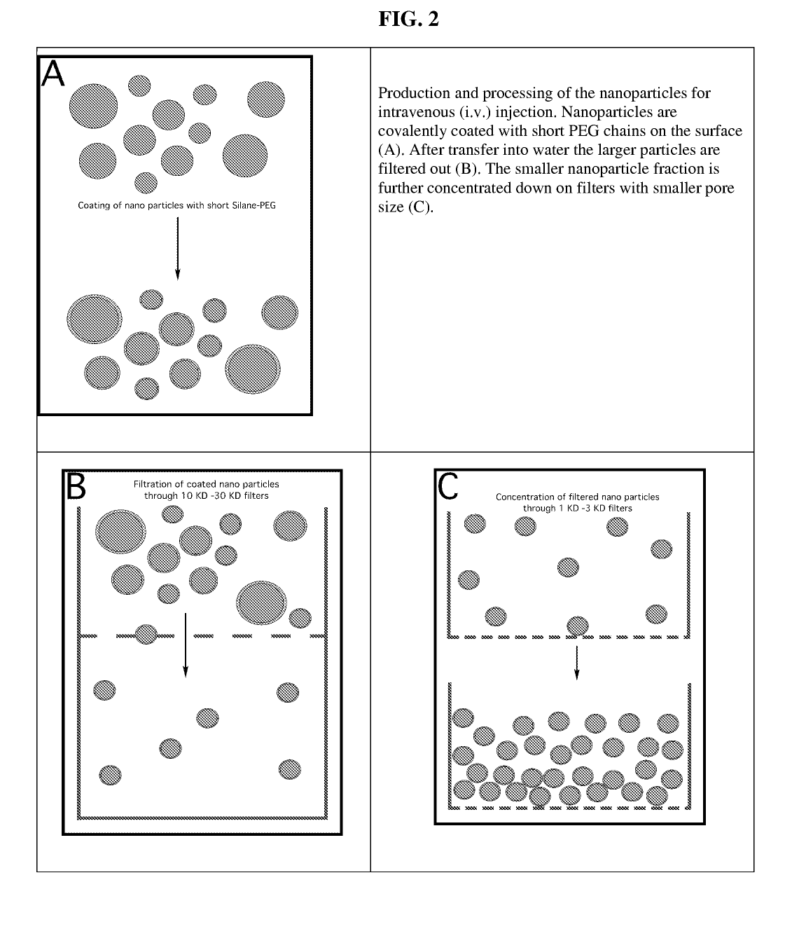

The coated (and uncoated) CS nanoparticles may include particles or aggregates that are too big to be passed through the kidney. The nanoparticle size distribution can be narrowed down through filtration using commercially available filter spin columns like the ones from Pall Corporation (10 KD or 30 KD sized Jumbo-, Macro-, Micro- and Nanosep columns), or products from other vendors like Millipore. The filtrate can be further concentrated in vitro through similar products but with smaller pore sizes (e.g., 1 KD or 3 KD sized Jumbo-, Macro-, Micro- and Nanosep columns) The CS nanoparticles can also be filtered using the ultra thin membranes developed by Simpore which have potential for greater fluxes and lower losses in the pores (due to their thin cross section). FIG. 2 depicts an exemplary method of CS nanoparticle coating and filtration using two filter passes.

We analyzed both size fractions (3 KD retentate and 30 KD retentate) of a typical nanoparticle preparation with a [Methoxy(Polyethyleneoxy)Propyl]-Trimethoxysilane coating through fluorescence correlation spectroscopy (FCS). We found a hydrodynamic diameter of 4 nm and a very narrow size distribution for the small 3 KD retentate and a 16 nm diameter for the larger 30 KD retentate.

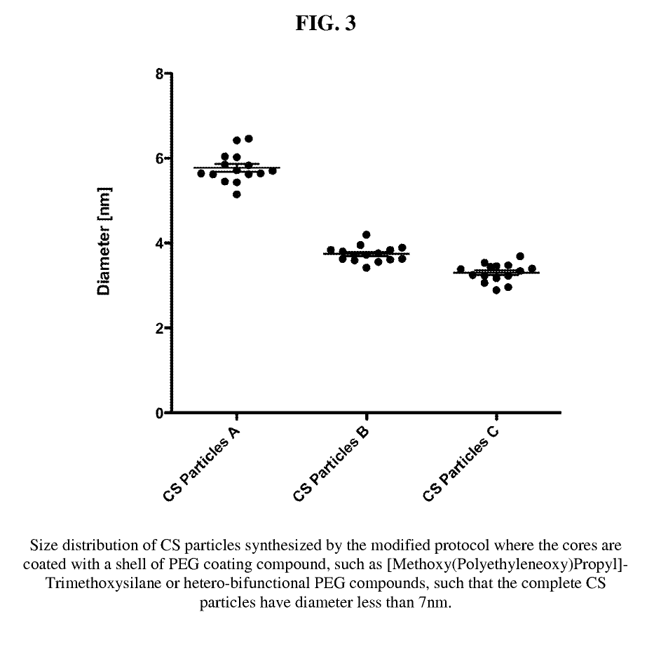

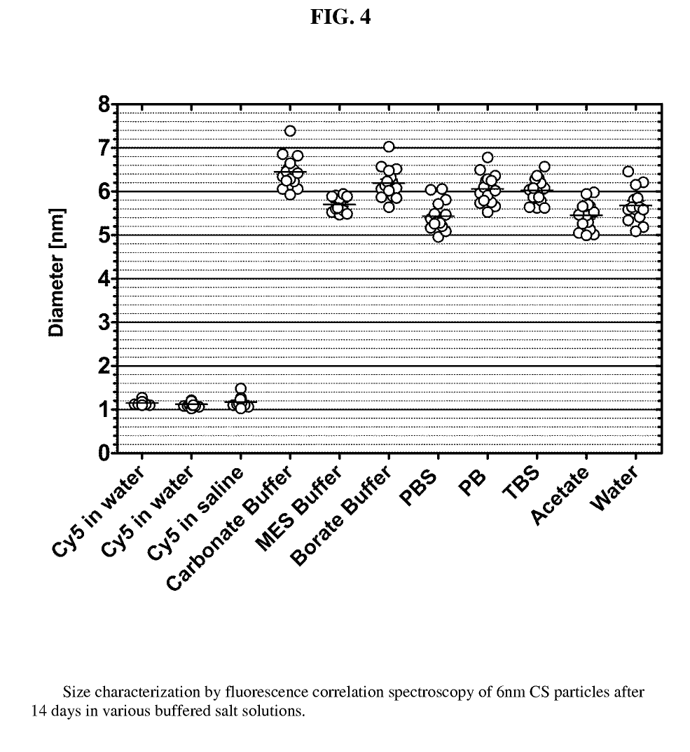

In yet another embodiment, the core of the CS particles are synthesized through the process described by Wiesner and Ow in US Patent Publication No. 2004/0101822A1, hereby incorporated by reference in its entirety, so that the core has diameter less than 5 nm, as measured by fluorescence correlation spectroscopy. The resulting cores are subsequently coated with a shell of PEG coating compound, such as [Methoxy(Polyethyleneoxy)Propyl]-Trimethoxysilane or hetero-bifunctional PEG compounds, such that the complete CS particles have diameter less than 7 nm. CS nanoparticles synthesized by this method have very narrow size distribution. Additional post-synthesis filtration process is not necessary to narrow the size distribution. FIG. 3 depicts fluorescence correlation spectroscopy size characterization of the CS particles from three different batches. The CS particles size distributions center at 6 nm, 4 nm, and 3 nm respectively. FIG. 4 depicts stability of the resultant CS particles after 14 days in various buffered salt solutions.

Preparation of dye precursor for 6 nm, 4 nm and 3 nm CS particles encapsulating Cy5.5 dyes:

In a nitrogen inertized glovebox, 1 mg of Cy5.5 maleimide dyes is dissolved in 1 mL dimethylsulfoxide (DMSO). Following complete dissolution of Cy5.5 maleimide dye in DMSO, 3-mercaptopropyltrimethoxysilane (MPTMS) is added to the solution at a molar ratio of 50:1 MPTMS:Cy5.5 Maleimide. Reaction is stirred on a magnetic store plate in the dark for at least 12 hours at room temperature.

Preparation of silica-based dye-rich core for 6 nm, 4 nm and 3 nm CS particles encapsulating Cy5.5 dyes:

Into a clean round-bottomed glass flask, appropriate amount of ethanol over methanol solvent is added. Concentrations of the reactants are as tabulated below. The reactants are added in the following order: water, dye precursor, tetraethylorthosilicate (TEOS), 2.0M ammonia in ethanol. The reaction is stirred on a magnetic stir plate at room temperature for at least 12 hours.

Coating of silica dye-rich core with PEG-coating compound to produce 6 nm, 4 nm, and 3 nm CS particles:

To a mixture containing silica-based dye-rich core as synthesized above, a silanized PEG compound, such as [Methoxy(Polyethyleneoxy)Propyl]-Trimethoxysilane, is added to produce a shell around the core. The amount of PEG compound added is as tabulated below. To produce particles with narrow size distribution, the PEG compound is added in small aliquots intermittently using a dosing positive displacement pipette, such as less than 5 mM every 10 to 15 minutes, and stirred continuously.

After all PEG compound has been added, the reaction mixture is stirred in the dark for 12 hours. The resultant CS particles are collected and purified via a dialysis process against the solvent methanol or ethanol to remove unreacted adducts. Further, the CS particles are dialyzed against deionized water to exchange the solvent. The CS particles in water can be then reconstituted into different buffered salt solutions for imaging applications.

TABLE I
Reactants (in molarity) for the Preparation and the Resulting Particle Size of CS Particles

| | | | | | | | Hydrodynamic |
|---|---|---|---|---|---|---|---|
| Sample | | | | [Dye | [PEG | | Diameter by FCS |
| Batch | [NH3] | [H2O] | [TEOS] | Precsursor] | compound] | Solvent | [nm] |
| CS Particles A | 0.2 | 0.855 | 0.05 | 2.88 × 10−5 | 0.15 | Ethanol | 5.7 +/− 0.3 |
| CS Particles B | 0.2 | 0.855 | 0.025 | 1.75 × 10−5 | 0.10 | Methanol | 3.7 +/− 0.2 |
| CS Particles C | 0.2 | 0.855 | 0.025 | 1.75 × 10−5 | 0.075 | Methanol | 3.3 +/− 0.2 |

### 3. Methods of Use

The accidental damage of ureters during abdominal surgery is a leading cause of complications and malpractice suits. Silica nanoparticles allow surgeons to visualize the ureters and the bladder through tissue using specially equipped laparoscopes. Visualization helps surgeons to avoid accidentally damaging these structures during vascular, urological, neurological and abdominal procedures. While a stent can be inserted into the ureters to illuminate these structures during surgery, such a procedure itself can damage the delicate structures. Moreover, the cost of involving an urologist to carry out this procedure greatly reduces its economic viability.

The notion of using fluorescent dyes to visualize the ureters was explored by Udshamadshuridze, which is hereby incorporated by reference. N. S. Udshamadshuridze, Intraoperative Visualization of the Ureters with Fluorescein Sodium Z. Urol. Nephr., Vol. 81; pp. 635-639. This study explores the use of fluorescein, a non-toxic dye approved for clinical use. Fluorescein, however, emits light with a wavelength that does not significantly transmit through (fatty) tissue. Therefore no known clinical adoption of this research has occurred since it was published in 1988.

The CS nanoparticles, particular PEG-coated CS nanoparticles having near infrared fluorescent compounds, may provide several advantages, when used to visualize the ureters of a subject. For example, the brightness enhancement achieved by encapsulating near infrared fluorescent dyes makes them superior to equal concentrations of free dye. The absorption coefficient of tissue is considerably smaller in the near infrared spectral region (650 nm-900 nm), so that light can penetrate more deeply through tissues of several centimeters thickness. Further, covalent bonding of the dyes to the silica network of the CS nanoparticles avoids dye leaking out into the surrounding tissue and accumulation in other organs or tissues. Such leakage would reduce contrast between the organs of interest and the surrounding tissue. A fluor that maintains its integrity after it has been injected into the body facilitates its clinical use as an imaging aid.

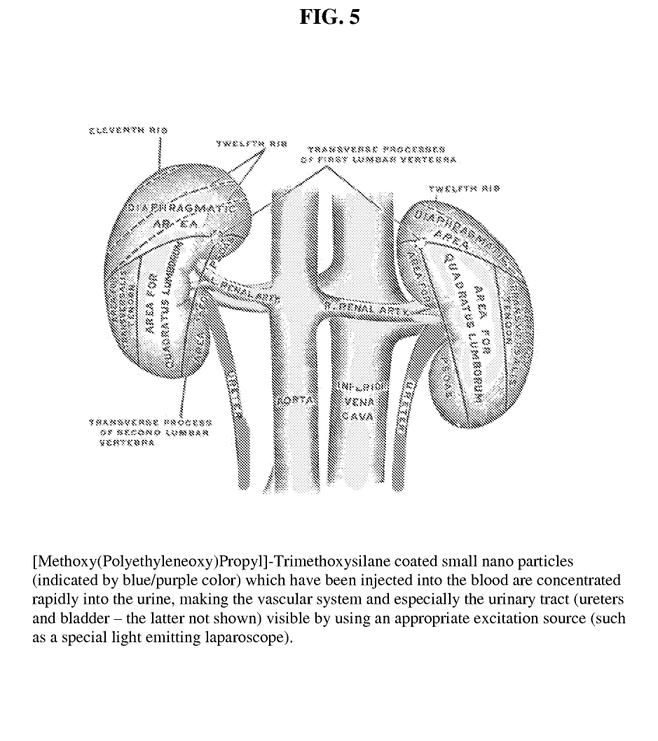

Accordingly, CS nanoparticles, particular PEG-coated CS nanoparticles, can be injected intravenously into humans or animals (For use in humans, GMP production and therefore other filters with corresponding pore sizes which have FDA approval would be used). The CS nanoparticles do not lose their fluorescence after being passed through the kidneys and concentrated in the urine. This allows surgeons, who are conducting abdominal surgery to view the ureters as urine flows to the bladder from the kidneys. These structures (ureters and bladder) are visible through fatty tissue using specially equipped laparoscopes thus avoiding accidental damage to these structures, as illustrated in FIG. 5.

In addition to imaging the ureters, the silica nanoparticles can be incorporated into sensor systems imparting temporal and spatial information to the viewer. For example, the pH sensor proof of principle described by Wiesner et al. is based on a silica nanoparticle that incorporates an environmentally sensitive dye and a reference dye for ratiometric sensing (“nanoparticle sensors”). The proof of principle pH sensor already demonstrated can be extended to measure other physiological parameters like metal status, oxygen status, redox status, and so forth that can be related to a change in dye emission. By injecting nanoparticle sensors or other nanoparticle-based sensing devices into the body, investigators and clinicians can image the body and gain other important physiochemical data.

The distribution of nanoparticles that are introduced into the body is a critical issue affecting their potential for in-vivo applications. It is desirable to have a rapid test where injected dots are viewed in the location of interest (using NIR imaging systems which can penetrate tissues) and then cleared quickly after providing the measurement or other functionality. One of the key issues in receiving FDA approval for injection of diagnostic nanoparticles is their clearance from the body. By ensuring rapid renal clearance, low residual material amounts, and integrity of the materials in vivo, a safer, more accurate test can be devised through the use of the coated CS nanoparticles described herein.

Further advantages and characteristics of the coated CS nanoparticles will become apparent from the following comparisons to uncoated CS nanoparticles.

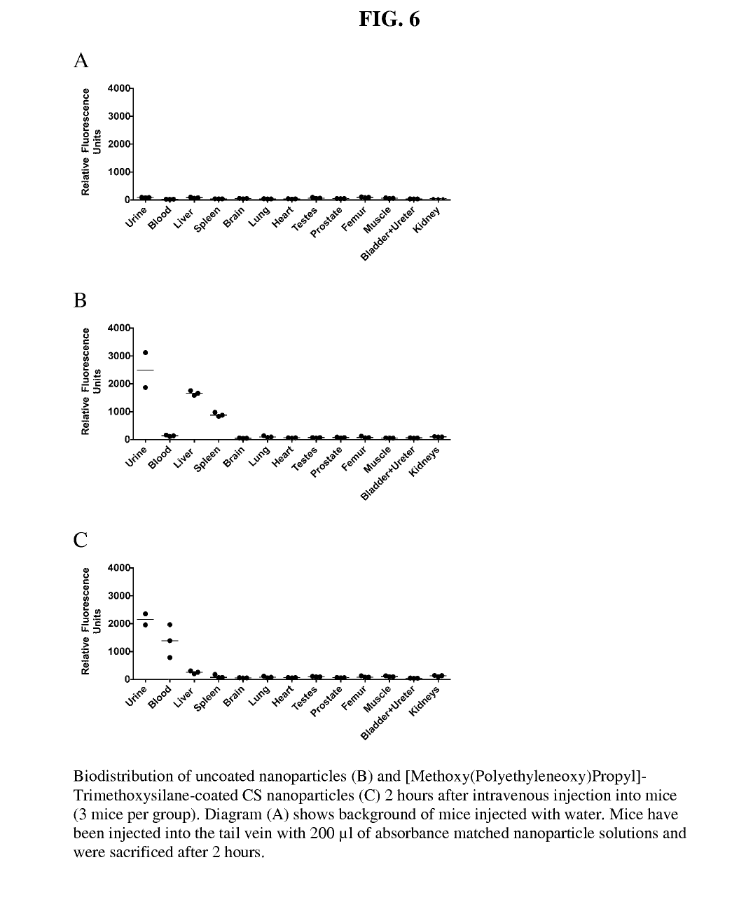

With reference to FIG. 6, it may be seen that the biodistribution of uncoated CS nanoparticles and [Methoxy(Polyethyleneoxy)Propyl]-Trimethoxysilane coated CS nanoparticles differs two hours after injection into mice. It can be seen that uncoated CS nanoparticles accumulated after two hours in the spleen and the liver. The urine concentration appears to be the same in this endpoint analysis (two hours after injection of the CS nanoparticles). However the PEG coated CS nanoparticles stay in the blood stream even after two hours and thus can be still secreted through the kidney.

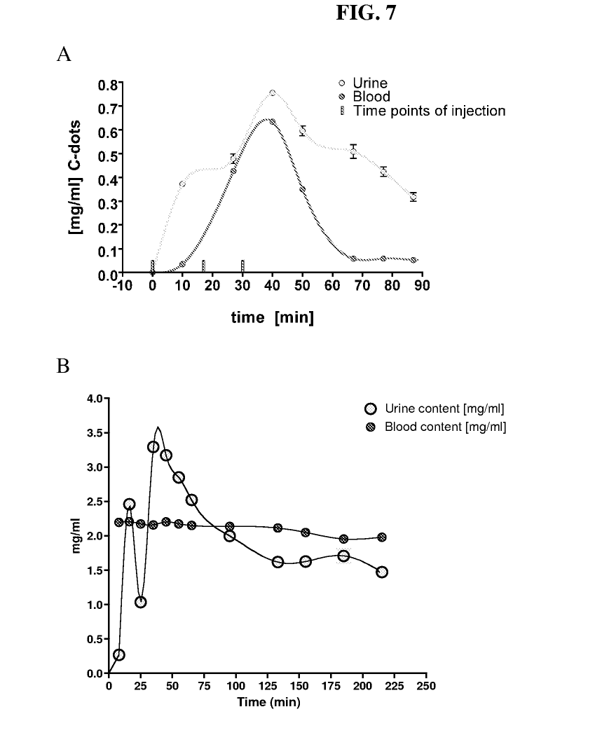

With reference to FIG. 7, Uncoated (A) and [Methoxy(Polyethyleneoxy)Propyl]-Trimethoxysilane coated C dots (B) were intravenously injected separately in two independent experiments into anaesthetized pigs. In both experiments, blood and urine was sampled over time and analyzed for CS nanoparticle content. Notably, the coated C dots (B) stay in the blood stream instead of getting depleted from it like the uncoated dots (A). It is also possible to inject much higher doses of PEG-coated CS nanoparticles than uncoated CS nanoparticles without risking aggregation of the CS nanoparticles as seen in the higher urine concentration achieved with the [Methoxy(Polyethyleneoxy)Propyl]-Trimethoxysilane coated CS nanoparticles (B). Higher doses of injected CS nanoparticles in the blood are translating directly into higher urine concentrations. It is desirable to achieve high concentrations of CS nanoparticles in the urine, because the detected fluorescence signals which are the bases for visualization of the ureter will be stronger.

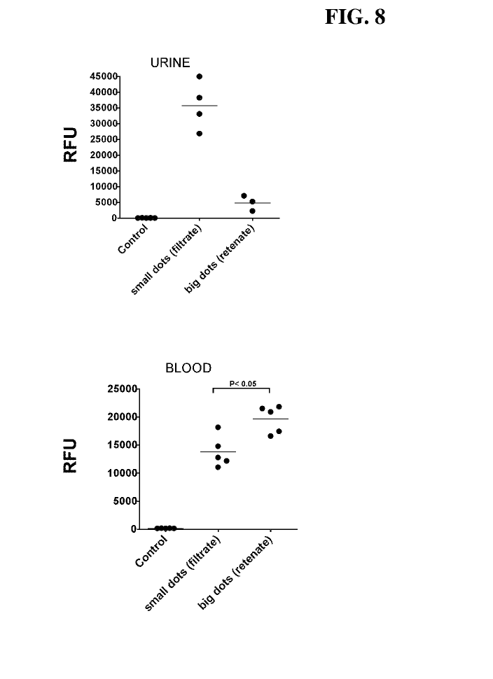

With reference to FIG. 8, the size distribution of the [Methoxy(Polyethyleneoxy)Propyl]-Trimethoxysilane coated nanoparticles have been shown to affect kidney excretion. Coated nanoparticles were filtered through a 30 K column. The filtrate was reconcentrated on a 3 K column. Both fractions, the retentate and the reconcentrated filtrate, were matched for the same fluorescence and injected separately into 5 mice per fraction. After 2 hours urine and blood was drawn and analyzed for fluorescence (RFU=relative fluorescence units). The 30 K filtrate fraction (smaller nanoparticles) clears to a higher degree in the urine than the retentate fraction (larger nanoparticles). In addition, the fluorescence detected in blood is significantly lower (p<0.05) in mice injected with the smaller nanoparticles fraction, because of the excretion of fluorescent nanoparticles. The control group shows the background signal of mice which have not been injected with nanoparticles.

What is claimed:

1. A fluorescent nanoparticle comprising:
a silica-based core comprising:
an organic functional group comprising a mercapto substituent; and
an organic fluorescent compound;
a silica shell; and
a silane-PEG compound;
wherein the silica shell encapsulates the silica-based core; and the silane-PEG compound is conjugated to the silica shell.

2. The nanoparticle of claim 1, wherein the diameter of the fluorescent nanoparticle 10 nm or less.

3. The nanoparticle of claim 1, wherein the silane-PEG compound comprises 25 or less repeating PEG units.

4. The nanoparticle of claim 3, wherein the silane-PEG compound is selected from the group consisting of: [Methoxy(Polyethyleneoxy)Propyl]-Trimethoxysilane, a [Methoxy(Polyethyleneoxy)Propyl]-Dimethoxysilane, and a [Methoxy(Polyethyleneoxy)Propyl]-Monomethoxysilane.

5. The nanoparticle of claim 1, wherein the nanoparticle is capable of emitting fluorescence light having a wavelength greater than 650 nm, upon excitation.

6. The nanoparticle of claim 1, wherein the silica shell comprises a silanol; and wherein the silane-PEG compound is conjugated to the silanol.

7. A composition comprising:
a plurality of nanoparticles of claim 1;
wherein less than 10% of the nanoparticles of the plurality of nanoparticles have silica shell diameters greater than 10 nm.

8. The fluorescent nanoparticle of claim 1, further comprising a ligand adapted to associate with a target molecule or substrate.

9. A fluorescent nanoparticle comprising:
a silica-based core comprising an organic fluorescent compound;
a silica shell;
a ligand adapted to associate with a target molecule or substrate; and
a silane-PEG compound;
wherein the silica shell encapsulates the silica-based core and the diameter of the fluorescent nanoparticle is between about 1 nm and about 100 nm.

10. The fluorescent nanoparticle of claim 9, wherein the silane-PEG compound is conjugated to the silica core and to the ligand adapted to associate with a target molecule or substrate.

11. A fluorescent nanoparticle comprising:
a silica-based network comprising an organic fluorescent material;
a polymeric ligand conjugated to an external surface of the silica-based network through a linker comprising an organic functional group;
a ligand adapted to associate with a target molecule or substrate;
a linker comprising an organic functional group; and
a silane-PEG compound conjugated to an external surface of the silica based network.
